(19) United States
(12) Patent Application Publication
(10) Pub. No.: US 2021/0120139 A1
(43) Pub. Date: Apr. 22, 2021

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Yutaka KOBAYASHI, Kanagawa (JP)

(73) Assignee: FUJI XEROX CO., LTD., Tokyo (JP)

(21) Appl. No.: 16/858,684

(22) Filed: Apr. 26, 2020

(30) Foreign Application Priority Data
Oct. 17, 2019 (JP) 2019-189932

(51) Int. Cl. H04N 1/00; H04L 29/08

(52) U.S. Cl. CPC H04N 1/00973; H04N 1/00244; H04L 67/146

(57) ABSTRACT

An information processing apparatus includes a memory and a processor configured to receive instruction information for downloading update data transmitted to a management target apparatus connected to a restricted network in which a direct connection to a public network is restricted, and change address information of a server apparatus for downloading the update data, included in the received instruction information, to address information of a server apparatus directly connected to the restricted network.

### CROSS-REFERENCE TO RELATED APPLICATIONS

This application is based on and claims priority under 35 USC 119 from Japanese Patent Application No. 2019-189932 filed Oct. 17, 2019.

### BACKGROUND

### (i) Technical Field

The present invention relates to an information processing apparatus, a non-transitory computer readable medium storing a program and an information processing method.

### (ii) Related Art

JP2006-127393A discloses a digital multifunction peripheral that obtains a file including the latest firmware version information by a File Transfer Protocol (FTP) from a server on the Internet to obtain firmware data of the version by the FTP thereby performing an automatic update.

### SUMMARY

Aspects of non-limiting embodiments of the present disclosure relate to an information processing apparatus and a non-transitory computer readable medium storing a program that enable, even in a case where a management target apparatus is connected to a restricted network in which a direct connection to a public network is restricted and update data to be downloaded by the management target apparatus is stored in a server apparatus connected to the public network, the management target apparatus to download the update data.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a memory and a processor configured to receive instruction information for downloading update data transmitted to a management target apparatus connected to a restricted network in which a direct connection to a public network is restricted, and change address information of a server apparatus for downloading the update data, included in the received instruction information, to address information of a server apparatus directly connected to the restricted network.

### BRIEF DESCRIPTION OF THE DRAWINGS

Exemplary embodiment(s) of the present invention will be described in detail based on the following figures, wherein:

FIG. 1 is a diagram showing a system configuration in a case where an image forming apparatus 20 is installed in a general network environment;

FIG. 2 is a sequence chart for explaining processing for the image forming apparatus 20 to obtain new firmware to perform an update in the system of FIG. 1;

FIG. 3 is a diagram showing a system configuration in a case where the image forming apparatus 20 is installed in a network environment where the image forming apparatus 20 is connected via an LGWAN 60;

FIG. 4 is a diagram for explaining a state in which the image forming apparatus 20 is not able to download firmware from a DL server 40;

FIG. 5 is a diagram showing a system configuration of an information processing system according to an exemplary embodiment of the present invention;

FIG. 6 is a block diagram showing a hardware configuration of a relay server 22 according to the exemplary embodiment of the present invention;

FIG. 7 is a block diagram showing a functional configuration of the relay server 22 according to the exemplary embodiment of the present invention;

FIG. 8 is a diagram showing an example of a URL correspondence table stored in a URL correspondence table storage unit 32;

FIG. 9 is a diagram for explaining an example of changing a URL by a URL change unit 34; and

FIG. 10 is a sequence chart for explaining processing for the image forming apparatus 20 to obtain new firmware to perform an update in the information processing system according to the exemplary embodiment of the present invention.

### DETAILED DESCRIPTION

Hereinafter, an exemplary embodiment of the present invention will be described in detail with reference to the drawings.

In the present exemplary embodiment, a case will be described in which an image forming apparatus 20 installed in a user environment such as a company, an office, or a workplace is managed as a management target apparatus, thereby updating firmware for the image forming apparatus 20.

Here, the firmware is a control program for controlling hardware of various apparatuses such as the image forming apparatus 20. There is a case where a firmware update is required so as to add a new function to the image forming apparatus 20 or to modify or change an existing function.

In a case where a service engineer or the like visits an installation location to perform such a firmware update to the image forming apparatus 20, it takes time and effort and it costs. Therefore, a method of updating such firmware via a network is used.

First, before describing an information processing system of the present exemplary embodiment, processing performed in a case where the image forming apparatus 20 of which the firmware is to be updated is connected to a general network environment will be described.

The image forming apparatus 20 is a so-called multifunction peripheral having a plurality of functions such as a print function, a scan function, a copy function, and a facsimile function.

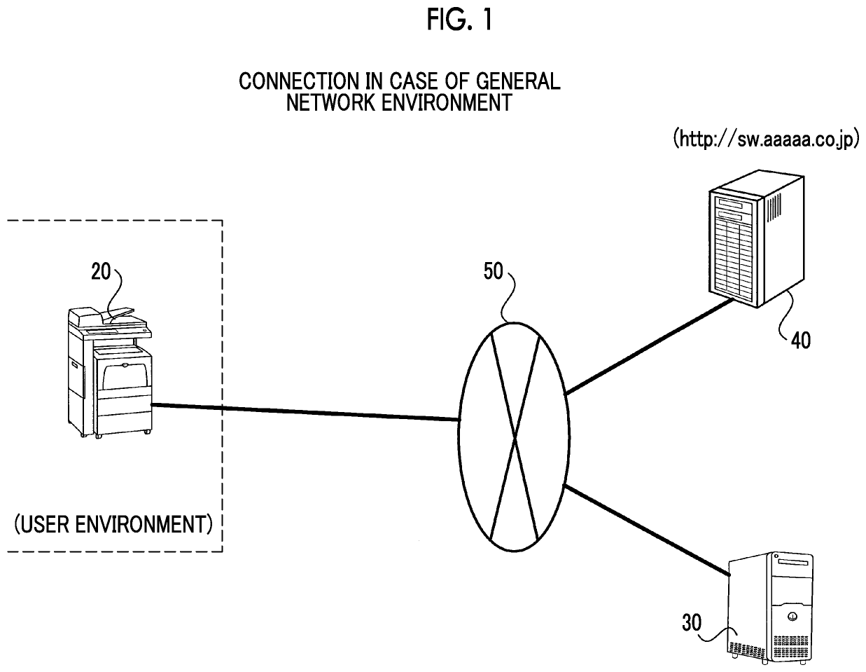

In the network environment shown in FIG. 1, the image forming apparatus 20 is connected to a management server 30 and a download (DL) server 40 via the Internet 50 which is a public network.

The management server 30 performs management of a count of the number of prints of the image forming apparatus 20 and a remaining amount of consumables via the Internet 50. Further, the management server 30 also performs management of the firmware used by the image forming apparatus 20. Such that, in a case where the management server 30 receives an inquiry from the image forming apparatus 20, the management server 30 executes processing of notifying the latest firmware version information, address information on a storage location where the firmware is stored, and the like.

The DL server 40 performs processing of storing a binary file such as firmware in advance such that another apparatus downloads the binary file via the Internet 50.

Here, in a case where the firmware to be updated for the image forming apparatus 20 is generated, the firmware is stored in the DL server 40, and URL (abbreviation for Uniform Resource Locator) information which is address information of the storage location is registered in the management server 30.

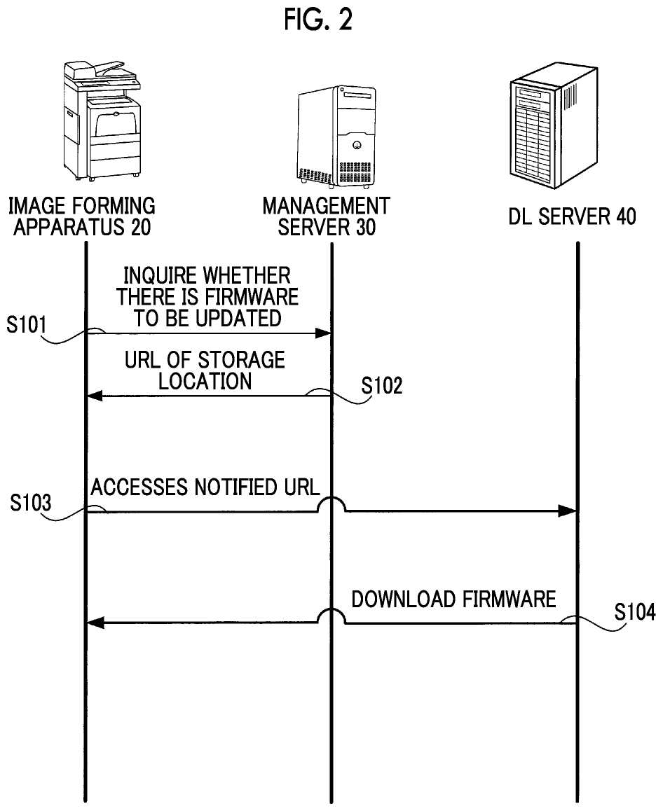

In the system shown in FIG. 1 in such a state, processing for the image forming apparatus 20 to obtain new firmware to perform an update will be described with reference to a sequence chart of FIG. 2.

First, in step S101, the image forming apparatus 20 inquires of the management server 30 whether there is firmware to be updated. Then, in response to the inquiry from the image forming apparatus 20, the management server 30 notifies the image forming apparatus 20 of the latest firmware version information and the URL information of the DL server 40 indicating the storage location of the firmware in step S102.

Then, the image forming apparatus 20 accesses the DL server 40 based on the notified URL information in step S103, and obtains the latest firmware by downloading in step S104.

In a case where the image forming apparatus 20 is installed in the general network environment shown in FIG. 1 as described above, by executing the above-described processing, the service engineer is able to execute an update of the firmware without going to the installation location of the image forming apparatus 20.

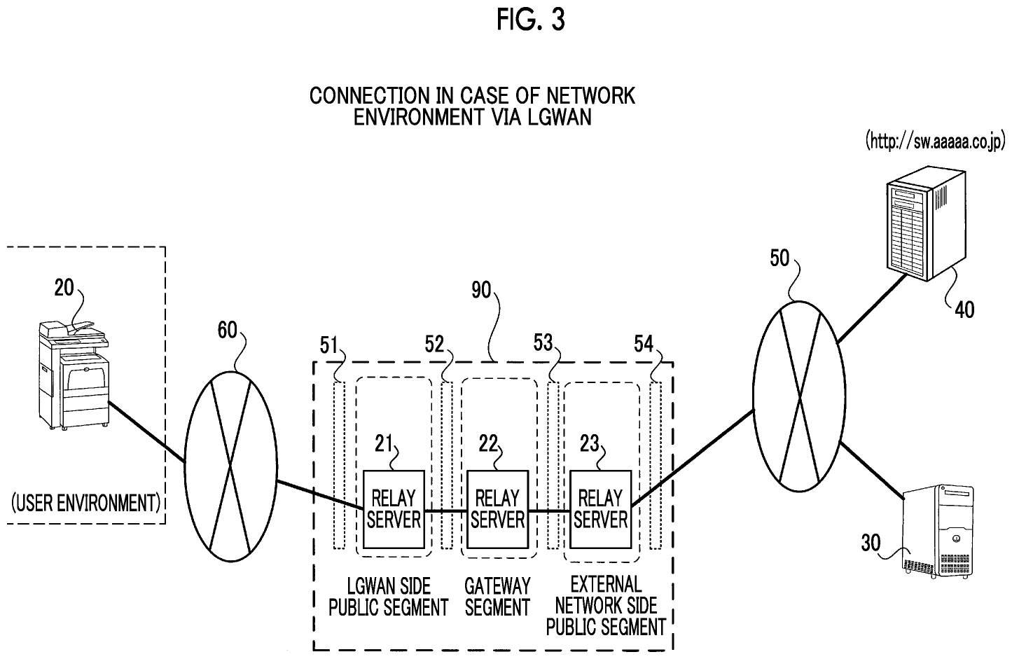

Next, a case of a network environment in which the user of the image forming apparatus 20 is a local government such as a city hall and the image forming apparatus 20 is connected to a Local Government Wide Area Network (LGWAN) which is a comprehensive administrative network will be described with reference to FIG. 3.

Here, the LGWAN is a network constructed for the purpose of facilitating communication between local governments and sharing information, and is a network dedicated to administrative organizations. The LGWAN is a restricted network that is separated from a public network such as the Internet and has restricted direct connection to the public network. The LGWAN is a wide area communication network to which only authorized local governments are permitted to connect, and in the LGWAN, the confidentiality is strictly protected because personal information of residents is handled.

Therefore, as shown in FIG. 3, in a case of a network environment in which the image forming apparatus 20 is installed in a city hall or the like and is connected to the LGWAN 60, it is not permitted to directly connect the image forming apparatus 20 to the management server 30 or the DL server 40 via the Internet 50.

In the system configuration shown in FIG. 3, a relay system 90 is provided between the LGWAN 60 and the Internet 50 in order to connect the image forming apparatus 20 installed in the network environment as described above to the management server 30 via the Internet 50.

However, it is not permitted to connect the LGWAN 60 to the Internet 50 by one server apparatus. Specifically, it is prohibited to directly transfer data obtained from the external network to the LGWAN 60, or to directly transfer data obtained from the LGWAN 60 to the external network. Further, a server apparatus that transfers data is permitted to transmit and receive data only to and from an adjacent server apparatus.

In order to satisfy such conditions, the relay system 90 has a configuration in which three relay servers 21 to 23 are connected in series, and in the relay system 90, firewalls 51 to 54 are provided between the relay servers 21 to 23 and between the LGWAN 60 and the Internet 50, respectively.

The relay server 21 transfers, as the LGWAN side public segment, data received from the LGWAN 60 to the relay server 22 and transfers the data received from the relay server 22 to the LGWAN 60.

In addition, the relay server 22 transfers data received from the relay server 21 to the relay server 23 and transfers, as a gateway segment, data received from the relay server 23 to the relay server 21.

Further, the relay server 23 transfers, as an external network side public segment, data received from the relay server 22 to another apparatus via the Internet 50 and transfers data received from the other apparatus to the relay server 22 via the Internet 50.

By connecting the LGWAN 60 and the Internet 50 via the relay system 90 as described above, the management server 30 is able to transmit and receive data to and from the image forming apparatus 20 via the Internet 50 to obtain various information such as the number of prints, thereby managing the image forming apparatus 20.

However, in such a network environment, downloading a binary file such as firmware via the Internet 50 by the image forming apparatus 20 connected to the LGWAN 60 is prohibited in consideration of malware threats and the like.

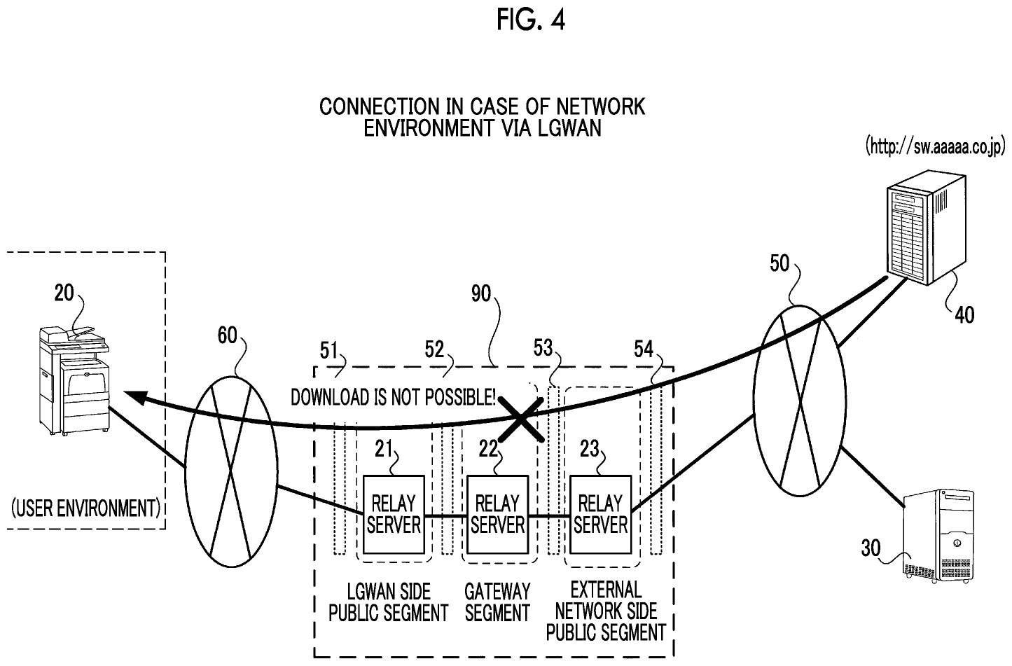

For this reason, as shown in FIG. 4, in a case where it is desired to perform an update of firmware as described above with respect to the image forming apparatus 20, since the firmware is stored in the DL server 40, the image forming apparatus 20 is not able to download the firmware from the DL server 40.

A system in which firmware is stored in a special environment permitted by a user that is a customer and downloaded from the storage location is also conceivable. However, in a case where it is desired to realize such a configuration, the management server 30 should perform individual operations such as returning the address information of the special location and accessing the address information of the special location without following the address information notified by the image forming apparatus 20 from the management server 30, only in a case where the image forming apparatus 20 is installed in a special network environment, in response to a firmware update inquiry from the image forming apparatus 20.

That is, in a case where it is desired to realize the above-described processing, the management server 30 or the image forming apparatus 20 should be designed in advance to perform such operations, and the corresponding cost becomes excessive.

Further, in a case where a service engineer visits a customer and directly operates the image forming apparatus 20 to update the firmware in order to update the firmware of the image forming apparatus 20 installed in such a special network environment, there are problems with cost and speed.

Therefore, in the information processing system of the present exemplary embodiment, by using a configuration described below, the image forming apparatus 20 which is the management target apparatus is able to download the firmware even in a case where the image forming apparatus 20 is connected to a restricted network called LGWAN 60 and the firmware to be downloaded by the image forming apparatus 20 is stored in the DL server 40 connected to the Internet 50.

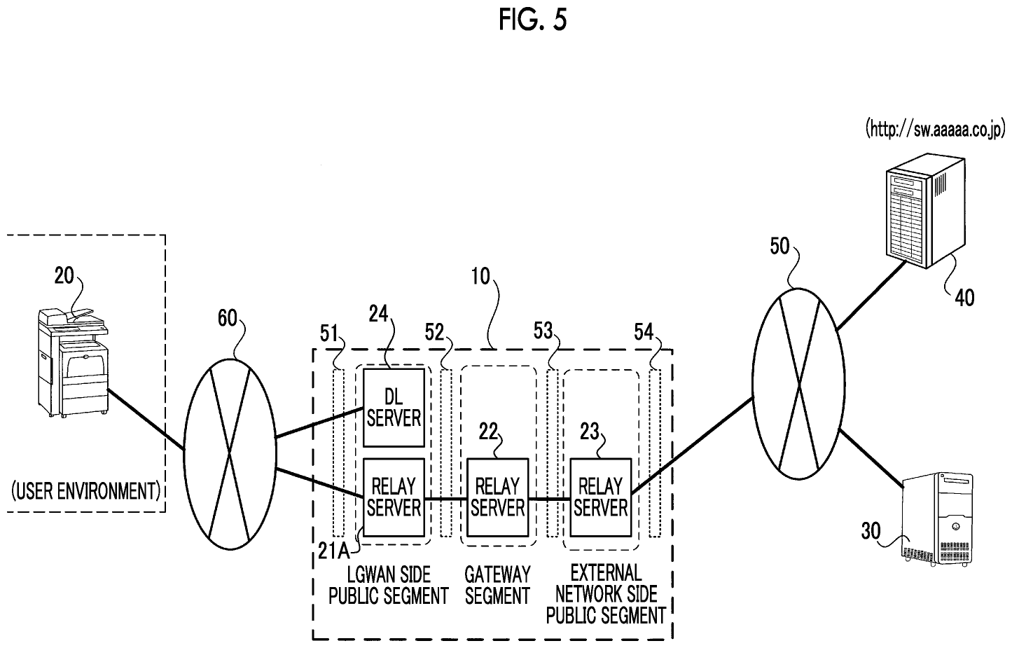

FIG. 5 is a diagram showing a system configuration of the information processing system according to one exemplary embodiment of the present invention.

As shown in FIG. 5, the information processing system according to the present exemplary embodiment has a configuration in which the relay system 90 is replaced with the relay system 10 in the system shown in FIG. 3.

The relay system 10 according to the present exemplary embodiment is different from the relay system 90 shown in FIG. 3 in that the relay server 21 is replaced with the relay server 21A and the DL server 24 is provided in the LGWAN side segment.

The DL server 24 has the same function as the DL server 40 and stores firmware to be updated by the image forming apparatus 20 in advance. In a case where the image forming apparatus 20 accesses the DL server 24, the DL server 24 performs processing of downloading the stored firmware.

Then, in addition to the functions of the relay server 21 shown in FIG. 3, the relay server 21A has a function of changing the URL information indicating the storage location of the firmware, included in the instruction information for instructing the update of the firmware transferred from the relay server 22, to the URL information indicating the storage location of the firmware in the DL server 24. Details of the function of the relay server 21A will be described later.

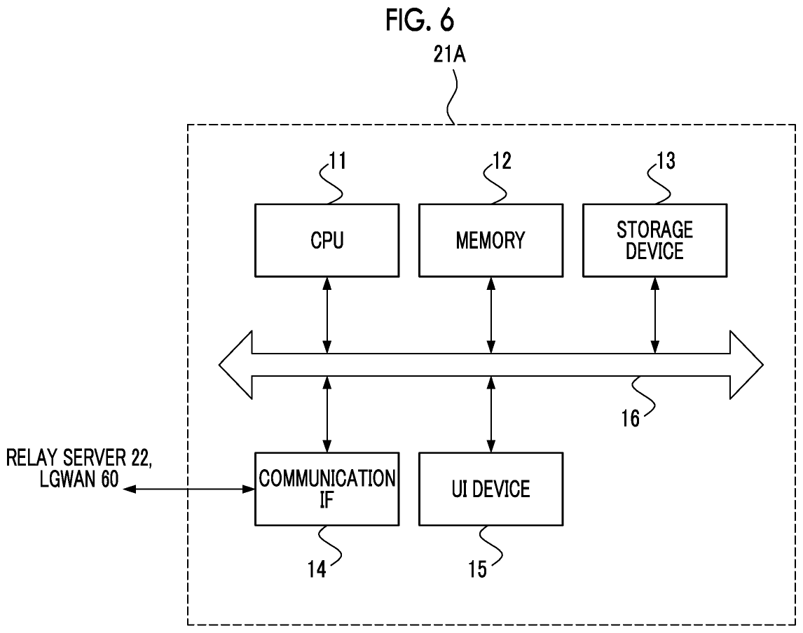

Next, a hardware configuration of the relay server 21A in the information processing system according to the present exemplary embodiment is shown in FIG. 6.

As shown in FIG. 6, the relay server 21A includes a CPU 11, a memory 12, a storage device 13 such as a hard disk drive, a communication interface (IF) 14 for transmitting and receiving data to and from external devices via the network, and a user interface (UI) device 15 including a touch panel or a liquid crystal display and a keyboard. The components are connected to each other via a control bus 16.

The CPU 11 is a processor that executes predetermined processing based on a control program stored in a memory 12 or the storage device 13 to control the operation of the relay server 21A. In the present exemplary embodiment, the description will be made assuming that the CPU 11 reads and executes a control program stored in the memory 12 or the storage device 13, but the program may be stored in a storage medium such as a CD-ROM and provided to the CPU 11.

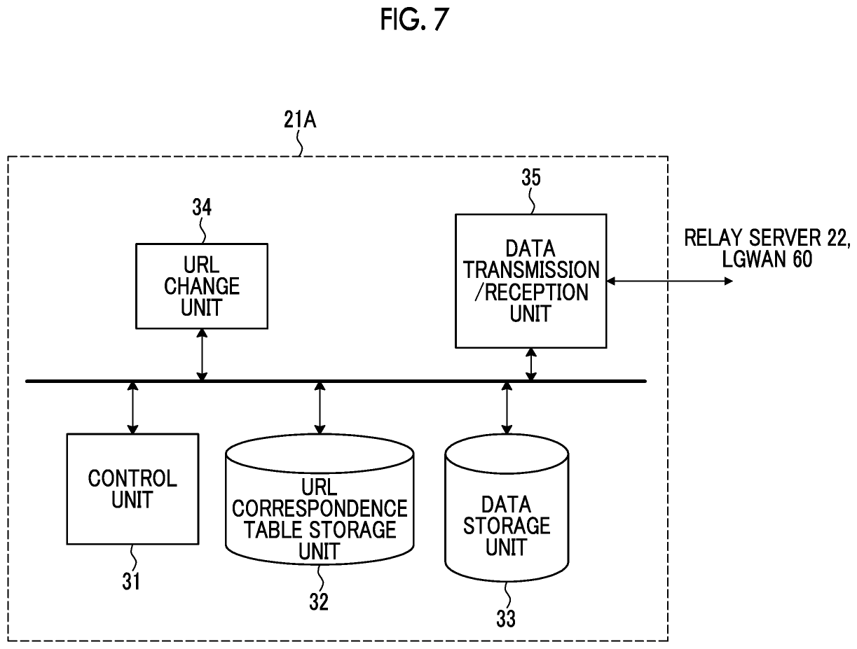

FIG. 7 is a block diagram showing a functional configuration of the relay server 21A realized by executing the above control program.

As shown in FIG. 7, the relay server 21A of the present exemplary embodiment includes a control unit 31, a URL correspondence table storage unit 32, a data storage unit 33, a URL change unit 34, and a data transmission/reception unit 35.

The data transmission/reception unit 35 transmits and receives data between the relay server 22 and the devices connected to the LGWAN 60. The data storage unit 33 temporarily stores the data received by the data transmission/reception unit 35.

The control unit 31 controls the entire operation of the relay server 21A, and executes processing of temporarily storing data received from the relay server 22 in the data storage unit 33 and then transferring the data to the image forming apparatus 20 via the LGWAN 60 or processing of temporarily storing data received from the image forming apparatus 20 via the LGWAN 60 in the data storage unit 33 and then transferring the data to the relay server 22.

Then, the URL correspondence table storage unit 32 stores a URL correspondence table in which a domain name in the URL information of the DL server 40 directly connected to the Internet 50 is associated with a domain name of the DL server 24 directly connected to the LGWAN 60.

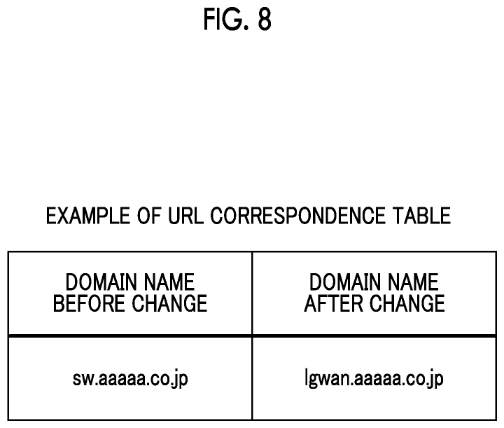

An example of the URL correspondence table stored in the URL correspondence table storage unit 32 is shown in FIG. 8.

Referring to FIG. 8, in the URL correspondence table, the domain name “sw.aaaaa.co.jp” and the domain name “lgwan.aaaaa.co.jp” are stored in association with each other. The domain name “sw.aaaaa.co.jp” is a domain name indicating the DL server 40, and the domain name “lgwan.aaaaa.co.jp” is a domain name indicating the DL server 24.

The URL change unit 34 changes the URL information of the DL server 40 included in the instruction information for instructing the firmware update from the management server 30, received from the relay server 22 by the data transmission/reception unit 35, to the URL information of the DL server 24 with reference to the URL correspondence table of the URL correspondence table storage unit 32.

That is, in a case where the data transmission/reception unit 35 receives, from the management server 30, the instruction information for downloading the firmware transmitted to the image forming apparatus 20 connected to the LGWAN 60 which is a restricted network in which a direct connection to a public network is restricted, the URL change unit 34 changes the URL information of the DL server 40 that is a server apparatus for downloading firmware, included in the instruction information received by the data transmission/reception unit 35, to the URL information of the DL server 24 that is a server apparatus directly connected to the LGWAN 60.

Specifically, the URL change unit 34 replaces the domain name portion in the URL information indicating the storage location of the server apparatus for downloading firmware, in the instruction information for instructing the firmware update, with a domain name stored in association with the domain name, thereby changing the URL information to URL information indicating a storage location of the DL server 24 directly connected to the LGWAN 60.

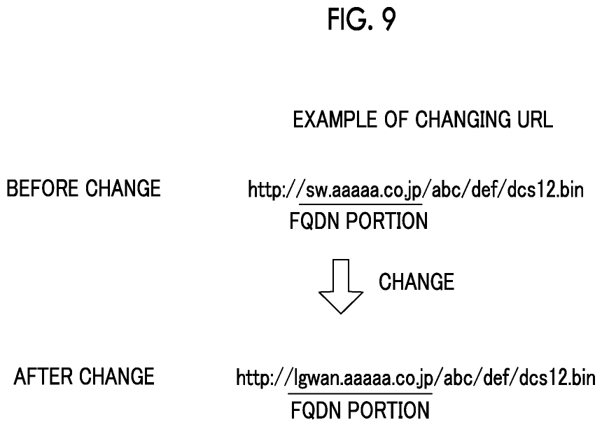

An example of changing the URL information by the URL change unit 34 is shown in FIG. 9.

Referring to FIG. 9, a state where the URL information is changed to “http://lgwan.aaaaa.co.jp/abc/def/dcs12.bin” is shown, in a case where the URL information before the URL information is changed is “http://sw.aaaaa.co.jp/abc/def/dcs12.bin”, by replacing the domain name in the URL information, specifically, the Fully Qualified Domain Name (FQDN) portion from “sw.aaaaa.co.jp” to “lgwan.aaaaa.co.jp”.

In the present exemplary embodiment, the file name of the firmware in a case of storing the firmware in the DL server 24, the folder name in which the file is stored, and the hierarchical structure of the location where the folder is stored are exactly the same as the file name, folder name, and the hierarchical structure in the DL server 40. Therefore, as described above, by changing only the FQDN portion in the URL information in a case of downloading the firmware from the DL server 40, it is possible to change to URL information that enables downloading the firmware from the DL server 24.

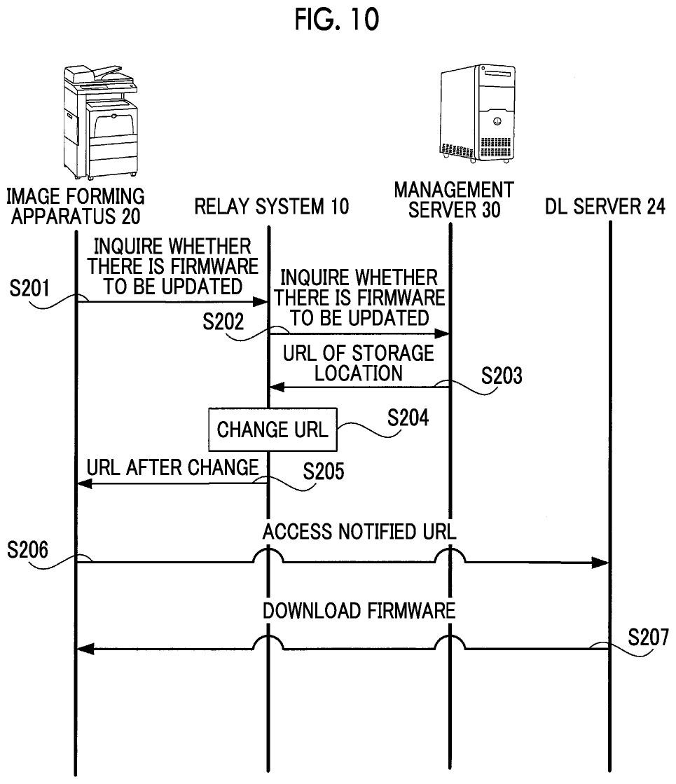

Next, processing for the image forming apparatus 20 to obtain new firmware to perform an update in the information processing system of the present exemplary embodiment shown in FIG. 5 will be described with reference to a sequence chart in FIG. 10.

First, in step S201, the image forming apparatus 20 inquires of the relay system 10 via the LGWAN 60 whether there is firmware to be updated. Then, in the relay system 10, the inquiry is sequentially transferred to the relay servers 21A, 22, and 23. As a result, the relay system 10 transfers the inquiry from the image forming apparatus 20 to the management server 30 via the Internet 50 in step S202.

Then, in response to the inquiry from the image forming apparatus 20, the management server 30 notifies the image forming apparatus 20 of the latest firmware version information and the URL information of the DL server 40 that is the storage location of the firmware in step S203.

In the relay system 10 that has received the notification from the management server 30, this notification is sequentially transferred to the relay servers 23 and 22 and reaches the relay server 21A. Then, the relay server 21A performs the above-described URL change processing in step S204. Specifically, the relay server 21A changes the URL information of the DL server 40 included in the firmware update instruction notified from the management server 30 to the URL information of the DL server 24 by using the change method shown in FIG. 9.

Then, in step S205, the relay server 21A transfers the firmware update instruction including the URL information after change to the image forming apparatus 20 via the LGWAN 60.

As a result, the image forming apparatus 20 accesses the DL server 24 based on the notified URL information in step S206, and obtains the latest firmware by downloading, in step S207.

As described above, in the information processing system of the present exemplary embodiment, the management server 30 returns the update instruction including the URL information of the DL server 40 in response to the inquiry about the firmware to be updated from the image forming apparatus 20, and the image forming apparatus 20 downloads the firmware by accessing the URL information included in the update instruction.

However, in the information processing system according to the present exemplary embodiment, since the URL information is rewritten in the relay server 21A in the relay system 10, the image forming apparatus 20 downloads the firmware by accessing not the DL server 40 connected to the Internet 50 but the DL server 24 directly connected to the LGWAN 60.

As described above, since it is authorized that the image forming apparatus 20 downloads the firmware which is a binary file from the DL server 24 connected only to the LGWAN 60, the image forming apparatus 20 is able to execute the update of the firmware without violating the security policy for the user.

In the embodiments above, the term “processor” refers to hardware in a broad sense. Examples of the processor includes general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Modification

In the above exemplary embodiment, a case where the firmware is updated for the image forming apparatus such as the multifunction peripheral has been described. However, the present invention is not limited thereto, and the present invention is similarly applicable to a case where an update is performed by transmitting update data such as firmware to another information processing apparatus such as a personal computer.

Also, the update data transmitted and updated to the information processing apparatus is not limited to firmware, and the present invention is similarly applicable to a case where data such as an application program is transmitted to an information processing apparatus as update data.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a memory; and
a processor configured to
receive instruction information for downloading update data transmitted to a management target apparatus connected to a restricted network in which a direct connection to a public network is restricted, and
change address information of a server apparatus for downloading the update data, included in the received instruction information, to address information of a server apparatus directly connected to the restricted network.

2. The information processing apparatus according to claim 1,
wherein the processor is configured to change URL information of the server apparatus for downloading the update data, included in the received instruction information, to URL information of the server apparatus directly connected to the restricted network.

3. The information processing apparatus according to claim 2,
wherein the memory stores a domain name in URL information of a server apparatus directly connected to the public network in association with a domain name of the server apparatus directly connected to the restricted network, and
the processor is configured to replace a domain name portion in the URL information of the server apparatus for downloading the update data, in the instruction information, with a domain name of the portion stored in association with the domain name to change to the URL information of the server apparatus directly connected to the restricted network.

4. The information processing apparatus according to claim 1,
wherein the update data is a control program for controlling an operation of the management target apparatus.

5. The information processing apparatus according to claim 2,
wherein the update data is a control program for controlling an operation of the management target apparatus.

6. The information processing apparatus according to claim 3,
wherein the update data is a control program for controlling an operation of the management target apparatus.

7. The information processing apparatus according to claim 4,
wherein the control program is firmware for controlling hardware of the management target apparatus.

8. The information processing apparatus according to claim 5,
wherein the control program is firmware for controlling hardware of the management target apparatus.

9. The information processing apparatus according to claim 6,
wherein the control program is firmware for controlling hardware of the management target apparatus.

10. A non-transitory computer readable medium storing a program causing a computer to execute a process, the process comprising:
receiving instruction information for downloading update data transmitted to a management target apparatus connected to a restricted network in which a direct connection to a public network is restricted; and
changing address information of a server apparatus for downloading the update data, included in the received instruction information, to address information of a server apparatus directly connected to the restricted network.

11. An information processing method comprising:
receiving instruction information for downloading update data transmitted to a management target apparatus connected to a restricted network in which a direct connection to a public network is restricted; and
changing address information of a server apparatus for downloading the update data, included in the received instruction information, to address information of a server apparatus directly connected to the restricted network.
